(19) United States
(12) Patent Application Publication
(10) Pub. No.: US 2024/0107412 A1
(43) Pub. Date: Mar. 28, 2024

(54) INFORMATION PROCESSING APPPARATUS AND INFORMATION PROCESSING METHOD

(71) Applicant: KDDI CORPORATION, Tokyo (JP)

(72) Inventor: Takashi ADACHI, Tokyo (JP)

(73) Assignee: KDDI CORPORATION, Tokyo (JP)

(21) Appl. No.: 18/107,167

(22) Filed: Feb. 8, 2023

(30) Foreign Application Priority Data
Sep. 28, 2022 (JP) 2022-155397

(51) Int. Cl. H04W 36/30; G01C 21/20; H04B 7/185

(52) U.S. Cl. CPC H04W 36/30; G01C 21/20; H04B 7/18513; B64U 10/00

(57) ABSTRACT

A flight management server having an assessment unit that assesses whether or not there is an object different from a flying vehicle within a detection range defined with respect to a position of the flying vehicle during flight; and a switching control unit that controls switching of communication performed by the flying vehicle during flight between terrestrial communication using terrestrial communication equipment and satellite communication using a communication satellite on the condition that the assessment unit has assessed that the object is not within the detection range.

### CROSS REFERENCE TO RELATED APPLICATION

Priority is claimed on Japanese Patent Application No. 2022-155397, filed Sep. 28, 2022, the content of which is incorporated herein by reference.

### BACKGROUND OF THE INVENTION

### Field of the Invention

The present invention relates to an information processing apparatus and an information processing method for processing information relating to a flying vehicle.

### Description of Related Art

Patent Document 1 (Japanese Unexamined Patent Application, First Publication No. 2017-168898) discloses a communication terminal that can communicate by switching between terrestrial communication via a terrestrial base station and satellite communication via a communication satellite.

### SUMMARY OF THE INVENTION

Therefore, an example of an objective of the present invention is to be able to increase the safety when the flying vehicle switches the communication means between terrestrial communication and satellite communication.

An information processing apparatus according to a first aspect of the present invention has an assessment unit that assesses whether or not there is an object different from a flying vehicle within a detection range defined with respect to a position of the flying vehicle during flight; and a switching control unit that controls switching of communication performed by the flying vehicle during flight between terrestrial communication using terrestrial communication equipment and satellite communication using a communication satellite on the condition that the assessment unit has assessed that the object is not within the detection range.

The switching control unit may control switching of the communication performed by the flying vehicle from the satellite communication to the terrestrial communication on the condition that the assessment unit has assessed that the object is not within the detection range and a radio signal strength of signals for the terrestrial communication is equal to or higher than a threshold value.

The switching control unit may control switching of the communication performed by the flying vehicle from the satellite communication to the terrestrial communication on the condition that the assessment unit has assessed that the object is not within the detection range, the radio signal strength of signals for the terrestrial communication is equal to or higher than a threshold value, and the radio signal strength of signals for the satellite communication is equal to or lower than a threshold value.

The switching control unit may control switching of the communication performed by the flying vehicle from the satellite communication to the terrestrial communication on the condition that the assessment unit has assessed that the object is not within the detection range and a radio signal strength of signals for the terrestrial communication received by the flying vehicle is equal to or higher than a threshold value.

The switching control unit may control switching of the communication performed by the flying vehicle from the terrestrial communication to the satellite communication on the condition that the assessment unit has assessed that the object is not within the detection range and a radio signal strength of signals for the terrestrial communication is equal to or lower than a threshold value.

The switching control unit may control switching of the communication performed by the flying vehicle from the terrestrial communication to the satellite communication on the condition that the assessment unit has assessed that the object is not within the detection range, the radio signal strength of signals for the terrestrial communication is equal to or lower than a threshold value, and the radio signal strength of signals for the satellite communication is equal to or higher than a threshold value.

The object may be another flying vehicle different from the flying vehicle; the information processing apparatus may further have an acquisition unit that acquires position information of the another flying vehicle; and the assessment unit, based on the position information, in a case in which the another flying vehicle is positioned within the detection range, may assess that the object is within the detection range, and in a case in which the another flying vehicle is not positioned within the detection range, may assess that the object is not within the detection range.

The object may be another flying vehicle different from the flying vehicle; the information processing apparatus may further have an acquisition unit that acquires scheduled flight information indicating scheduled flight positions of the other flying vehicle at respective times; and the assessment unit, in a case in which the scheduled flight position at a current time is included within the detection range, may assess that the object is within the detection range, and in a case in which the scheduled flight position at a current time is not included within the detection range, may assess that the object is not within the detection range.

The information processing apparatus may further have an acquisition unit that acquires map information of a region corresponding to the detection range; and the assessment unit, in a case in which an object indicated by the map information is positioned within the detection range, may assess that the object is within the detection range, and in a case in which an object indicated by the map information is not positioned within the detection range, may assess that the object is not within the detection range.

The information processing apparatus may further have an acquisition unit that acquires measurement information measured within the detection range by the flying vehicle during flight; and the assessment unit, in a case in which the measurement information indicates that a measured object is positioned within the detection range, may assess that the object is within the detection range, and in a case in which the measurement information does not indicate that a measured object is positioned within the detection range, may assess that the object is not within the detection range.

The assessment unit may assess whether or not the object is within the detection range in accordance with whether or not the measured object is a registered object that has been preset.

The assessment unit may determine the detection range based on a time period required for switching the communication performed by the flying vehicle between the terrestrial communication and the satellite communication.

The assessment unit may determine the detection range based on scheduled flight information indicating scheduled flight positions of the flying vehicle at respective times.

An information processing method according to a second aspect of the present invention, executed by a processor, includes assessing whether or not there is an object different from a flying vehicle within a detection range defined with respect to a position of the flying vehicle during flight; and switching communication performed by the flying vehicle during flight between terrestrial communication using terrestrial communication equipment and satellite communication using a communication satellite on the condition that the object has been assessed as not being within the detection range in the assessing.

### BRIEF DESCRIPTION OF THE DRAWINGS

FIG. 1 is a schematic diagram of a flight management system according to an embodiment.

FIG. 2 is a block diagram of a flight management system according to an embodiment.

FIG. 3 is a schematic diagram for explaining a method for an assessment unit to determine a detection range.

FIG. 4 is a schematic diagram for explaining a method for the assessment unit to assess whether or not there is another flying vehicle within the detection range.

FIG. 5 is a schematic diagram for explaining a method for the assessment unit to assess whether or not there is an obstacle within the detection range.

FIG. 6 is a diagram depicting a flow chart for an information processing method executed by a flight management server according to an embodiment.

### DETAILED DESCRIPTION OF THE INVENTION

### [Outline of Flight Management System S]

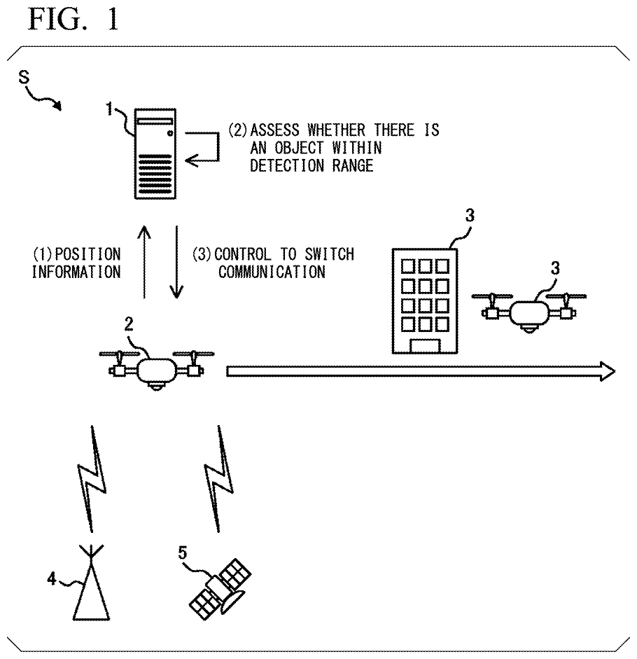

FIG. 1 is a schematic diagram of a flight management system S according to the present embodiment. The flight management system S includes a flight management server 1 and multiple flying vehicles 2. The flight management system S may include other terminals, apparatuses, or the like. The flight management server 1 is a computer for managing information relating to the flight of the flying vehicles 2. The flight management server 1 is a single computer or multiple computers. Additionally, the flight management server 1 may be one or multiple virtual servers that operate on a cloud, which is a set of computer resources.

The flying vehicles 2 are unmanned flying apparatuses, such as drones, that fly in the air. Additionally, the flying vehicles 2 may be manned flying apparatuses such as aircraft or flyable cars. The flying vehicles 2 fly in accordance with manual operations by a user, or fly along a scheduled flight path that has been preset. The flying vehicles 2 may fly near objects 3 such as other flying vehicles or buildings.

The flying vehicles 2 have a communication unit for transmitting and receiving information, by radio communication, to and from the flight management server 1, via prescribed communication means. Additionally, the flying vehicles 2 have a measurement unit, such as an infrared sensor, a laser sensor, an ultrasonic sensor, or the like for measuring whether or not there is an object within a measurement range defined with respect to the position of the flying vehicle 2.

The flying vehicles 2 can switch the communication means used during flight between terrestrial communication using terrestrial communication equipment 4, and satellite communication using a communication satellite 5.

The communication equipment 4 is, for example, a terrestrially installed base station that relays communication signals transmitted by each of the flight management server 1 and the flying vehicles 2. The communication equipment 4 supports communication standards such as 3G (Generation), 4G/LTE (Long-Term Evolution), 5G, etc.

The communication satellite 5 is an artificial satellite located in outer space, for relaying communication signals transmitted, for example, by each of the flight management server 1 and the flying vehicles 2. The communication satellite 5 supports a prescribed satellite communication standard.

An outline of the process executed by the flight management system S according to the present embodiment will be explained below. The flight management server 1 acquires position information indicating the position of a flying vehicle 2 during flight ((1) in FIG. 1).

The flight management server 1 assesses whether or not there is an object 3 different from the flying vehicle 2 within a detection range defined with respect to the position of the flying vehicle 2 during flight ((2) in FIG. 1).

The detection range is, for example, a range within a prescribed distance from the position of the flying vehicle 2. The object 3 is, for example, a building, a flying vehicle different from the flying vehicle 2, or the like.

The flight management server 1, on the condition that it has been assessed that there is no object 3 within the detection range, controls switching of the communication performed by the flying vehicle 2 during flight between terrestrial communication and satellite communication ((3) in FIG. 1). The flight management server 1, for example, transmits, to the flying vehicle 2, control information for switching the communication performed by the flying vehicle 2 between terrestrial communication and satellite communication.

Thus, the flight management system S switches the communication performed by the flying vehicle 2 between terrestrial communication and satellite communication after confirming that there is no object 3 near the flying vehicle 2. In this way, the flight management system S prevents an object 3 from approaching too close while the flying vehicle 2 cannot communicate, thereby increasing the safety when switching the communication means of the flying vehicle 2 between terrestrial communication and satellite communication.

### [Configuration of Flight Management System S]

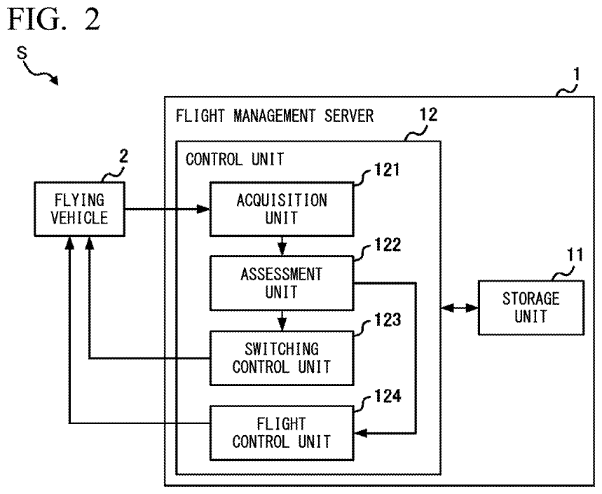

FIG. 2 is a block diagram of a flight management system S according to the present embodiment. In FIG. 2, the arrows indicate the main data flow, and there may be data flow other than that indicated in FIG. 2. In FIG. 2, the respective blocks indicate functional unit configurations rather than hardware (apparatus) unit configurations. For this reason, the blocks indicated in FIG. 2 may be installed in a single apparatus, or may be installed so as to be divided between multiple apparatuses. The exchange of data between the blocks may be performed by any means, such as by a data bus, a network, a portable storage medium, etc.

The flight management server 1 has a storage unit 11 and a control unit 12. The storage unit 11 is a storage medium including a ROM (Read-Only Memory), a RAM (Random Access Memory), a hard disk drive, etc. The storage unit 11 prestores a program to be executed by the control unit 12. The storage unit 11 may be provided outside the flight management server 1, and in that case, may exchange data with the control unit 12 via a network.

The control unit 12 has an acquisition unit 121, an assessment unit 122, a switching control unit 123, and a flight control unit 124. The control unit 12 is a processor such as, for example, a CPU (Central Processing Unit), that functions as the acquisition unit 121, the assessment unit 122, the switching control unit 123, and the flight control unit 124 by executing a program stored in the storage unit 11. At least some of the functions of the control unit 12 may be executed by an electrical circuit. Additionally, at least some of the functions of the control unit 12 may be realized by the control unit 12 executing a program that is executed via a network.

Hereinafter, the process executed by the flight management system S will be explained in detail. Each of the multiple flying vehicles 2 during flight identifies its own position by using, for example, GNSS (Global Navigation Satellite System), and transmits position information indicating the identified position to the flight management server 1 by terrestrial communication or by satellite communication. Additionally, the flying vehicles 2 transmit, to the flight management server 1, by means of terrestrial communication or satellite communication, communication information indicating which communication means, of terrestrial communication or satellite communication, is being used, and the radio signal strength of communication signals that are being received.

In the flight management server 1, the acquisition unit 121 acquires the position information and the communication information transmitted by each of the multiple flying vehicles 2, and stores said information in the storage unit 11 in association with a flying vehicle ID (Identification) for identifying the flying vehicle 2 that is the transmission source. The acquisition unit 121 may acquire position information from another apparatus holding the position information of the flying vehicles 2. The flight management server 1 performs subsequent processes on each of the multiple flying vehicles 2 or performs the subsequent processes on one of the flying vehicles 2 designated by the user.

The assessment unit 122 determines a detection range for detecting an object 3 that is defined with respect to the position of the flying vehicle 2 during flight indicated by the position information acquired by the acquisition unit 121. The detection range is a range for detecting an object 3 different from the flying vehicle 2 for determining whether or not to switch the communication means of the flying vehicle 2 between terrestrial communication and satellite communication.

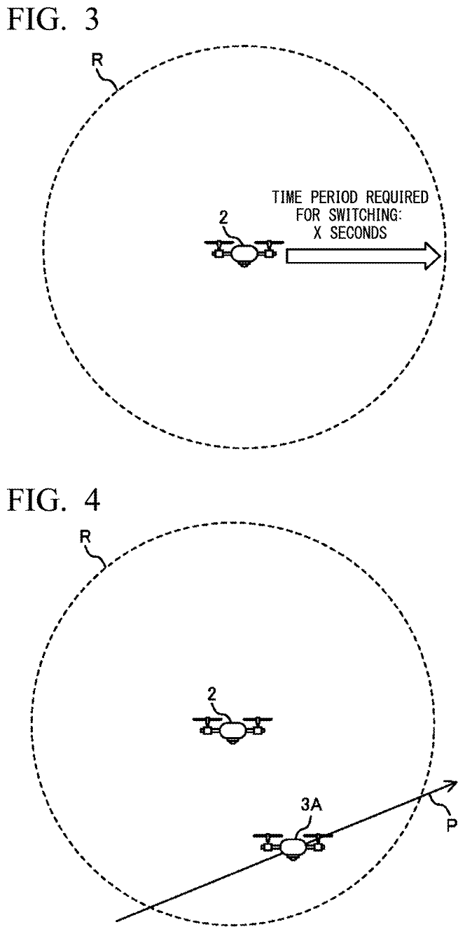

FIG. 3 is a schematic diagram for explaining the method by which the assessment unit 122 determines the detection range R. The assessment unit 122, for example, determines a range within a prescribed distance from the position of the flying vehicle 2 to be the detection range R. The prescribed distance may be a fixed value, or may be a value set by the user in an information terminal used by the user.

Additionally, the assessment unit 122 may, for example, determine the detection range R based on the time required to switch the communication performed by the flying vehicle 2 between terrestrial communication and satellite communication. In this case, the determination unit 122, for example, calculates the distance that can be reached by the flying vehicle 2 by multiplying the flight speed of the flying vehicle 2 with the time required to switch the communication performed by the flying vehicle 2 between terrestrial communication and satellite communication, which is prestored in the storage unit 11. The flight speed of the flying vehicle 2 may be a value that is prestored in the storage unit 11, or may be calculated based on the past flight history of the flying vehicle 2. The assessment unit 122 determines a range within the distance that can be reached from the position of the flying vehicle 2 to be the detection range R. In this way, the flight management system S can determine a detection range R in accordance with the time required to switch the communication performed by the flying vehicle 2 between terrestrial communication and satellite communication, and can detect objects 3 with a relatively high probability of approaching nearby while the flying vehicle 2 cannot communicate.

Additionally, the assessment unit 122 may determine the detection range R based on scheduled flight information indicating scheduled flight positions of the flying vehicle 2 at respective times. In this case, the acquisition unit 121 acquires the scheduled flight information indicating the scheduled flight positions (also referred to as the scheduled flight path) of the flying vehicle 2 at respective times. The assessment unit 122, for example, determines the detection range R to be a range forward along the advancement direction of the flying vehicle 2 indicated by the scheduled flight information acquired by the acquisition unit 121, in a range that is within a prescribed distance or within a distance that can be reached from the position of the flying vehicle 2. As a result thereof, the flight management system S can avoid detection of objects 3 (for example, objects to the rear of the flying vehicle 2) for which the probability of approaching nearby while the flying vehicle 2 cannot communicate is relatively low.

The acquisition unit 121 acquires information for assessing whether or not there is an object 3 different from the flying vehicle 2 within the detection range R determined by the assessment unit 122. The acquisition unit 121 may acquire measurement information transmitted by the flying vehicle 2 as the information for determining whether or not there is an object 3 within the detection range R. In this case, the flying vehicle 2 uses a measurement unit to measure whether or not there is an object (hereinafter referred to as a measured object) within the detection range R, and transmits to the flight management server 1, by terrestrial communication or satellite communication, measurement information indicating whether or not there is a measured object within the detection range R. The acquisition unit 121 acquires the measurement information transmitted by the flying vehicle 2.

Additionally, the acquisition unit 121 may acquire, as the information for assessing whether or not there is an object 3 within the detection range R, scheduled flight information indicating scheduled flight positions of each of multiple flying vehicles 2 at respective times. In this case, the acquisition unit 121, for example, acquires scheduled flight information that is prestored in the storage unit 11, or acquires scheduled flight information from another apparatus that holds the scheduled flight information of the flying vehicles 2.

Additionally, the acquisition unit 121 may acquire, as the information for assessing whether or not there is an object 3 within the detection range R, map information of a region corresponding to the detection range R. In this case, the acquisition unit 121, for example, acquires map information of the region corresponding to the detection range R from map information that is prestored in the storage unit 11, or acquires map information of the region corresponding to the detection range R from another apparatus holding map information. The map information is, for example, information including the positions (coordinates, etc.) of buildings, such as houses, located on the ground. The map information may be three-dimensional map information that includes the heights of the buildings in addition to the positions of the buildings.

Additionally, the acquisition unit 121 may acquire a radio signal map that is prestored in the storage unit 11. The radio signal map is, for example, information indicating the radio signal strengths of signals for both terrestrial communication and satellite communication at respective positions in the sky. The radio signal map may be a three-dimensional radio signal map indicating the radio signal strength at each altitude at the respective positions in the sky. The radio signal map is, for example, generated by simulating the radio signal strengths of communication signals at the respective positions in the sky, or generated by actually measuring the radio signal strengths of communication signals at the respective positions in the sky.

The assessment unit 122 assesses whether or not there is an object 3 different from the flying vehicle 2 within the detection range R based on the information acquired by the acquisition unit 121. In the case in which the object 3 is another flying vehicle 3A, which is a flying vehicle different from the flying vehicle 2, then the assessment unit 122 assesses whether or not the other flying vehicle 3A is within the detection range R based on the position information or the scheduled flight information of the other flying vehicle 3A. The other flying vehicle 3A is, for example, one of the multiple flying vehicles 2 included in the flight management system S.

FIG. 4 is a schematic diagram for explaining the method by which the assessment unit 122 assesses whether or not there is another flying vehicle 3A within the detection range R. FIG. 4 illustrates the detection range R, the positions of the flying vehicle 2 and the other flying vehicle 3A, and the scheduled flight path P of the other flying vehicle 3A.

The assessment unit 122, for example, based on the position information for the other flying vehicle 3A acquired by the acquisition unit 121, assesses that there is an object 3 within the detection range R in the case in which the other flying vehicle 3A is positioned within the detection range R, and assesses that there is no object 3 within the detection range R in the case in which the other flying vehicle 3A is not positioned within the detection range R. In this way, the flight management system S can use the actual position of the other flying vehicle 3A to detect the other flying vehicle 3A near the flying vehicle 2.

Additionally, the assessment unit 122, for example, based on the scheduled flight information (scheduled flight path P) of the other flying vehicle 3A acquired by the acquisition unit 121, assesses that there is an object 3 within the detection range R in the case in which the scheduled flight position of the other flying vehicle 3A at the current time is included within the detection range R, and assesses that there is no object 3 within the detection range R in the case in which the scheduled flight position of the other flying vehicle 3A at the current time is not included within the detection range R. In this way, the flight management system S can use scheduled positions at which the other flying vehicle 3A is to fly to detect the other flying vehicle 3A near the flying vehicle 2.

In the case in which the object 3 is an obstacle 3B that is an object different from the flying vehicle 2, the assessment unit 122, for example, assesses whether or not the obstacle 3B is within the detection range R based on map information or measurement information. The obstacle 3B is, for example, a building such as a house, a plant such as a tree, or an animal such as a bird.

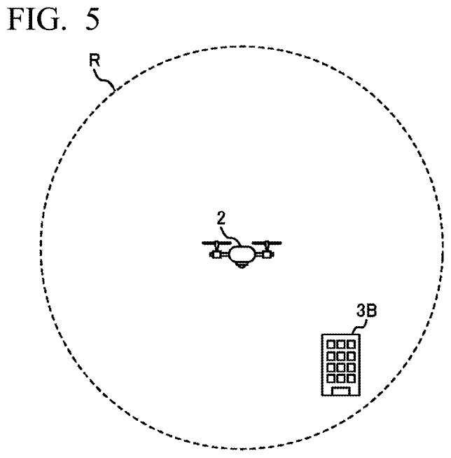

FIG. 5 is a schematic diagram for explaining the method by which the assessment unit 122 assesses whether or not there is an obstacle 3B the detection range R. FIG. 5 illustrates the detection range R and the positions of the flying vehicle 2 and the obstacle 3B. The assessment unit 122, for example, based on map information acquired by the assessment unit 122, assesses that there is object 3 within the detection range R in the case in which an object (obstacle 3B) such as a building, indicated by the map information, is positioned within the detection range R, and assesses that there is no object 3 within the detection range R in the case in which an object indicated by the map information is not positioned within the detection range R. In the case in which the map information is three-dimensional map information, the assessment unit 122 may assess whether or not, among objects indicated by the map information, there is an object positioned at the altitude of the flying vehicle 2 during flight within the detection range R. In this way, the flight management system S can use the map information indicating the positions of objects to detect obstacles 3B near the flying vehicle 2.

The assessment unit 122, for example, based on the measurement information acquired by the acquisition unit 121, assesses that there is an object 3 within the detection range R in the case in which the measurement information indicates that there is a measured object (obstacle 3B) positioned within the detection range R, and assesses that there is no object 3 within the detection range R in the case in which the measurement information does not indicate that there is a measured object positioned within the detection range R. In this way, the flight management system S can detect an obstacle 3B near the flying vehicle 2 by measuring the positions of objects near the flying vehicle 2.

The assessment unit 122 may assess whether or not there is an object 3 within the detection range R in accordance with whether or not a measured object indicated by measurement information is a registered object that has been preset. In this case, the storage unit 11 prestores, for example, information indicating registered objects that are to be detection targets or registered objects that are not to be detection targets, set by the user in an information terminal used by the user. The assessment unit 122 assesses whether or not a measured object is a registered object by means of a known object recognition process, and assesses whether or not there is a measured object that is a registered object or a measured object that is not a registered object within the detection range R. In this way, the flight management system S can narrow down the detection targets to specific objects or can exclude specific objects from the detection targets.

The switching control unit 123 controls switching of the communication performed by the flying vehicle 2 during flight between terrestrial communication and satellite communication on the condition that the assessment unit 122 has assessed that there is no object 3 within the detection range R. The switching control unit 123, for example, controls switching of the communication performed by a flying vehicle 2 that is performing satellite communication from satellite communication to terrestrial communication on the condition that the assessment unit 122 has assessed that there is no object 3 within the detection range R. The switching control unit 123, for example, controls switching of the communication performed by a flying vehicle 2 that is performing terrestrial communication from terrestrial communication to satellite communication on the condition that the assessment unit 122 has assessed that there is no object 3 within the detection range R.

The switching control unit 123, for example, switches the communication performed by the flying vehicle 2 between terrestrial communication and satellite communication by transmitting to the flying vehicle 2, by terrestrial communication or satellite communication, control information for switching the communication means between terrestrial communication and satellite communication. The flying vehicle 2 switches the communication means between terrestrial communication and satellite communication in accordance with the control information received from the flight management server 1.

In this way, the flight management system S reduces the flying vehicle 2 from approaching too close the object 3 while the flying vehicle 2 cannot communicate, thereby increasing the safety when the flying vehicle 2 switches the communication means between terrestrial communication and satellite communication.

Additionally, the switching control unit 123 may control switching of the communication performed by a flying vehicle that is performing satellite communication from satellite communication to terrestrial communication on the condition that the assessment unit 122 has assessed that there is no object 3 within the detection range R and the radio signal strength of terrestrial communication signals is equal to or higher than a threshold value. The radio signal strength of the terrestrial communication signals used for the assessment is the radio signal strength at the position of the flying vehicle 2 indicated by a radio signal map acquired by the acquisition unit 121 or the radio signal strength of communication signals received by the flying vehicle 2 indicated by communication information acquired by the acquisition unit 121. In the case in which the radio signal map is a three-dimensional radio signal map, the switching control unit 123 may make the assessment by using the radio signal strength on the radio signal map corresponding to the position and altitude of the flying vehicle 2 during flight.

In this way, the flight management system S reduces an occurrence of situations in which the flying vehicle 2 becomes unable to communicate after having switched the communication means of the flying vehicle 2 from satellite communication to terrestrial communication, thereby increasing the safety when the flying vehicle 2 switches the communication means between terrestrial communication and satellite communication.

Additionally, the switching control unit 123 may control switching of the communication performed by a flying vehicle 2 that is performing satellite communication from satellite communication to terrestrial communication on the condition that the assessment unit 122 has assessed that there is no object 3 within the detection range R, the radio signal strength of terrestrial communication signals is equal to or higher than a threshold value, and the radio signal strength of satellite communication signals is equal to or lower than a threshold value. The radio signal strengths of the terrestrial communication and satellite communication signals used for the assessment are the radio signal strengths at the position of the flying vehicle 2 indicated by radio signal maps acquired by the acquisition unit 121 or the radio signal strengths of communication signals received by the flying vehicle 2 indicated by communication information acquired by the acquisition unit 121. In the case in which the radio signal maps are three-dimensional radio signal maps, the switching control unit 123 may make the assessment by using the radio signal strengths on the radio signal maps corresponding to the position and altitude of the flying vehicle 2 during flight.

In this way, the flight management system S can have the communication means of the flying vehicle 2 be switched from satellite communication to terrestrial communication only in situations in which the radio signal strength of the satellite communication signals has decreased, thereby reducing the flying vehicle 2 frequently switching the communication means between terrestrial communication and satellite communication.

Additionally, the switching control unit 123 may control switching of the communication performed by a flying vehicle that is performing terrestrial communication from terrestrial communication to satellite communication on the condition that the assessment unit 122 has assessed that there is no object 3 within the detection range R and the radio signal strength of terrestrial communication signals is equal to or lower than a threshold value. The radio signal strength of the terrestrial communication signals used for the assessment is the radio signal strength at the position of the flying vehicle 2 indicated by a radio signal map acquired by the acquisition unit 121 or the radio signal strength of communication signals received by the flying vehicle 2 indicated by communication information acquired by the acquisition unit 121. In the case in which the radio signal map is a three-dimensional radio signal map, the switching control unit 123 may make the assessment by using the radio signal strength on the radio signal map corresponding to the position and altitude of the flying vehicle 2 during flight.

In this way, the flight management system S can have the communication means of the flying vehicle 2 be switched from terrestrial communication to satellite communication only in situations in which the radio signal strength of the terrestrial communication signals has decreased, thereby reducing the flying vehicle 2 frequently switching the communication means between terrestrial communication and satellite communication.

Additionally, the switching control unit 123 may control switching of the communication performed by a flying vehicle 2 that is performing terrestrial communication from terrestrial communication to satellite communication on the condition that the assessment unit 122 has assessed that there is no object 3 within the detection range R, the radio signal strength of terrestrial communication signals is equal to or lower than a threshold value, and the radio signal strength of satellite communication signals is equal to or higher than a threshold value. The radio signal strengths of the terrestrial communication and satellite communication signals used for the assessment are the radio signal strengths at the position of the flying vehicle 2 indicated by radio signal maps acquired by the acquisition unit 121 or the radio signal strengths of communication signals received by the flying vehicle 2 indicated by communication information acquired by the acquisition unit 121. In the case in which the radio signal maps are three-dimensional radio signal maps, the switching control unit 123 may make the assessment by using the radio signal strengths on the radio signal maps corresponding to the position and altitude of the flying vehicle 2 during flight.

In this way, the flight management system S reduces an occurrence of situations in which the flying vehicle 2 becomes unable to communicate after having switched the communication means of the flying vehicle 2 from terrestrial communication to satellite communication, thereby increasing the safety when the flying vehicle 2 switches the communication means between terrestrial communication and satellite communication.

The switching control unit 123 may control switching of the communication performed by the flying vehicle 2 between terrestrial communication and satellite communication by using different threshold values for the case of switching from terrestrial communication to satellite communication and the case of switching from satellite communication to terrestrial communication. For example, the threshold value for the radio signal strength of the terrestrial communication signals for the case of switching from satellite communication to terrestrial communication is greater than the threshold value for the radio signal strength of the terrestrial communication signals for the case of switching from terrestrial communication to satellite communication. In this way, the flight management system S can reduce the flying vehicle 2 frequently switching the communication means between terrestrial communication and satellite communication in the vicinity of the radio signal strength threshold values.

The flight control unit 124 implements control to stop the flying vehicle 2 on the condition that the assessment unit 122 has assessed that there is an object 3 within the detection range R (i.e., the switching control unit 123 will not implement control to switch the communication performed by the flying vehicle 2 between terrestrial communication and satellite communication). The flight control unit 124, for example, transmits, to the flying vehicle 2, control information for stopping (hovering, landing, etc.) the flying vehicle 2. The flying vehicle 2 stops in accordance with the control information received from the flight management server 1.

In this way, the flight management system S can prevent the flying vehicle 2 from leaving the area in which communication is possible in the case in which the communication means of the flying vehicle 2 cannot be switched due to an object 3 being near the flying vehicle 2.

### [Flow of Information Processing Method]

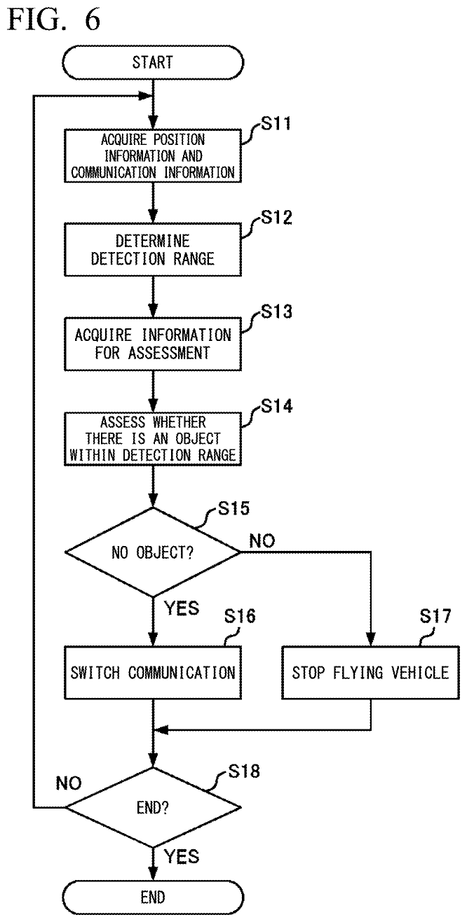

FIG. 6 is a diagram depicting a flow chart of the information processing method executed by the flight management server 1 according to the present embodiment. In the flight management server 1, the acquisition unit 121 acquires position information and communication information transmitted respectively by multiple flying vehicles 2, and stores the information in the storage unit 11 in association with flying vehicle IDs for identifying the flying vehicles 2 that are the transmission sources (S11).

The assessment unit 122 determines a detection range R for detecting objects 3, defined with respect to the position of the flying vehicle 2 during flight indicated by the position information acquired by the acquisition unit 121 (S12). The acquisition unit 121 acquires information for assessing whether or not there is an object 3 different from the flying vehicle 2 within the detection range R determined by the assessment unit 122 (S13). The acquisition unit 121 acquires, as the information for assessing whether or not there is an object 3 within the detection range R, for example, measurement information transmitted by the flying objects 2, scheduled flight information indicating the scheduled flight positions at respective times for each of the multiple flying objects 2, or map information of a region corresponding to the detection range R.

The assessment unit 122, based on the information acquired by the acquisition unit 121, assesses whether or not there is an object 3 different from the flying vehicle 2 within the detection range R (S14). The switching control unit 123, on the condition that the assessment unit 122 has assessed that the object 3 is not within the detection range R (YES in S15), implements control to switch the communication performed by the flying vehicle 2 during flight between terrestrial communication and satellite communication (S16).

The switching control unit 123, for example, switches the communication performed by the flying vehicle 2 between terrestrial communication and satellite communication by transmitting, to the flying vehicle 2, by terrestrial communication or satellite communication, control information for switching the communication means between terrestrial communication and satellite communication. The flying vehicle 2 switches the communication means between terrestrial communication and satellite communication in accordance with control information received from the flight management server 1.

The flight control unit 124, on the condition that the assessment unit 122 has assessed that there is an object 3 within the detection range R (NO in S15), implements control to stop the flying vehicle 2 (S17). The flight control unit 124, for example, transmits, to the flying vehicle 2, control information for stopping (hovering, landing, etc.) the flying vehicle 2. The flying vehicle 2 stops in accordance with the control information received from the flight management server 1.

If prescribed ending conditions (for example, that the user has performed a manual ending operation) are not satisfied (NO in S18), then the flight management server 1 repeats steps S11 to S17. If the prescribed ending conditions are satisfied (YES in S18), then the flight management server 1 ends the process.

### Effects of Embodiments

If there is a time period during which the flying vehicle 2 cannot communicate while switching the communication means between terrestrial communication and satellite communication, then there is a possibility that the flying vehicle 2 will approach too close to another object 3 due to not being able to accurately recognize the positional relationship between the flying vehicle 2 and the other object 3 during that time period. The flight management system S according to the present embodiment switches the communication performed by the flying vehicle 2 between terrestrial communication and satellite communication on the condition that there is no object 3 within the detection range R defined with respect to the position of the flying vehicle 2. In this way, the flight management system S prevents the flying vehicle 2 from approaching too close to an object 3 while the flying vehicle 2 cannot communicate, thereby increasing the safety when switching the communication means of the flying vehicle 2 between terrestrial communication and satellite communication.

### First Modified Example

In the embodiments described above, the flight management server 1 functions as an information processing apparatus that performs processes for switching the communication means of the flying vehicle 2 in accordance with whether or not there is an object 3 within the detection range R. In the present modified example, one of the multiple flying vehicles 2 functions as an information processing apparatus that performs processes for switching the communication means of that flying vehicle 2 in accordance with whether or not there is an object 3 within the detection range R.

In this case, processors in the flying vehicles 2 function, for example, as an acquisition unit 121, an assessment unit 122, a switching control unit 123, and a flight control unit 124. According to the flight management system S in the present modified example, even in the case in which there is no flight management server 1, one of the flying vehicles 2 can perform a process for switching the communication means of the flying vehicle 2 in accordance with whether or not there is an object 3 within the detection range R.

### Second Modified Example

In the embodiments described above, the flight management server 1 functions as an information processing apparatus that performs processes for switching the communication means of the flying vehicle 2 in accordance with whether or not there is an object 3 within the detection range R. In the present modified example, the flight management server 1 and a flying vehicle 2 cooperate to function as an information processing apparatus that performs processes for switching the communication means of the flying vehicle 2 in accordance with whether or not there is an object 3 within the detection range R.

In this case, for example, a processor in the flight management server 1 functions as an acquisition unit 121 and an assessment unit 122, and a processor in the flying vehicle 2 functions as a switching control unit 123 and a flight control unit 124. In the flight management server 1, the assessment unit 122 assesses whether or not there is an object 3 within the detection range R. Then, in the flying vehicle 2, based on the assessment results in the flight management server 1, the switching control unit 123 commences control for switching the communication performed by the flying vehicle 2 between terrestrial communication and satellite communication, or the flight control unit 124 commences control for stopping the flying vehicle 2. According to the flight managements system S in the present modified example, the processing load can be distributed between the flight management server 1 and the flying vehicle 2.

Due to the present embodiments, it is possible to contribute to Goal 9, “Build resilient infrastructure, promote sustainable industrialization, and foster innovation” among the sustainable development goals (SDGs) advanced by the United Nations.

As mentioned above, several features are proposed in connection with an information processing apparatus and an information processing method for processing information regarding flying vehicles.

The flying vehicles fly while transmitting and receiving information to and from a server by means of communication. However, there are cases in which a time period of a few seconds to several tens of seconds is required when a flying vehicle switches the communication means between terrestrial communication and satellite communication, and during that time period, the flying vehicle is not able to communicate. In situations in which the flying vehicle cannot communicate, there is a possibility that the flying vehicle will approach too close to another object due to not being able to accurately recognize the positional relationship between the flying vehicle and the object.

At least one exemplary embodiment, for example, provides the effect of being able to increase the safety when the flying vehicle switches the communication means between terrestrial communication and satellite communication.

Although the present embodiment has been explained above, the technical scope is not limited to what is described regarding the embodiments above, and various modifications and changes are possible within the scope thereof. For example, all or some of the apparatuses may be configured in a functionally or physically distributed or integrated manner, in arbitrary units. Additionally, new embodiments obtained by arbitrarily combining multiple embodiments are also included among the present embodiments. The effects of the new embodiments obtained by combination are a combination of the effects of the original embodiments.

The processors in the flight management server 1 and the flying vehicles 2 execute the steps (processes) included in the information processing method indicated in FIG. 6. The processors in the flight management server 1 and the flying vehicles 2, for example, execute the information processing method indicated in FIG. 6 by executing a program for executing the information processing method indicated in FIG. 6. Some of the steps included in the information processing method indicated in FIG. 6 may be omitted, the order of the steps may be changed, and multiple steps may be performed simultaneously.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An information processing apparatus comprising:
an assessment unit that assesses whether or not there is an object different from a flying vehicle within a detection range defined with respect to a position of the flying vehicle during flight; and
a switching control unit that controls switching of communication performed by the flying vehicle during flight between terrestrial communication using terrestrial communication equipment and satellite communication using a communication satellite on the condition that the assessment unit has assessed that the object is not within the detection range.

2. The information processing apparatus according to claim 1, wherein
the switching control unit controls switching of the communication performed by the flying vehicle from the satellite communication to the terrestrial communication on the condition that the assessment unit has assessed that the object is not within the detection range and a radio signal strength of signals for the terrestrial communication is equal to or higher than a threshold value.

3. The information processing apparatus according to claim 2, wherein
the switching control unit controls switching of the communication performed by the flying vehicle from the satellite communication to the terrestrial communication on the condition that the assessment unit has assessed that the object is not within the detection range, the radio signal strength of signals for the terrestrial communication is equal to or higher than a threshold value, and the radio signal strength of signals for the satellite communication is equal to or lower than a threshold value.

4. The information processing apparatus according to claim 2, wherein
the switching control unit controls switching of the communication performed by the flying vehicle from the satellite communication to the terrestrial communication on the condition that the assessment unit has assessed that the object is not within the detection range and a radio signal strength of signals for the terrestrial communication received by the flying vehicle is equal to or higher than a threshold value.

5. The information processing apparatus according to claim 1, wherein
the switching control unit controls switching of the communication performed by the flying vehicle from the terrestrial communication to the satellite communication on the condition that the assessment unit has assessed that the object is not within the detection range and a radio signal strength of signals for the terrestrial communication is equal to or lower than a threshold value.

6. The information processing apparatus according to claim 5, wherein
the switching control unit controls switching of the communication performed by the flying vehicle from the terrestrial communication to the satellite communication on the condition that the assessment unit has assessed that the object is not within the detection range, the radio signal strength of signals for the terrestrial communication is equal to or lower than a threshold value, and the radio signal strength of signals for the satellite communication is equal to or higher than a threshold value.

7. The information processing apparatus according to claim 1, wherein:
the object is another flying vehicle different from the flying vehicle;
the information processing apparatus further has an acquisition unit that acquires position information of the another flying vehicle; and
the assessment unit, based on the position information, in a case in which the another flying vehicle is positioned within the detection range, assesses that the object is within the detection range, and in a case in which the another flying vehicle is not positioned within the detection range, assesses that the object is not within the detection range.

8. The information processing apparatus according to claim 1, wherein:
the object is another flying vehicle different from the flying vehicle;
the information processing apparatus further includes an acquisition unit that acquires scheduled flight information indicating scheduled flight positions of the other flying vehicle at respective times; and
the assessment unit, in a case in which the scheduled flight position at a current time is included within the detection range, assesses that the object is within the detection range, and in a case in which the scheduled flight position at a current time is not included within the detection range, assesses that the object is not within the detection range.

9. The information processing apparatus according to claim 1, further comprising:
an acquisition unit that acquires map information of a region corresponding to the detection range;
wherein the assessment unit, in a case in which an object indicated by the map information is positioned within the detection range, assesses that the object is within the detection range, and in a case in which an object indicated by the map information is not positioned within the detection range, assesses that the object is not within the detection range.

10. The information processing apparatus according to claim 1, further comprising:
an acquisition unit that acquires measurement information measured within the detection range by the flying vehicle during flight;
wherein the assessment unit, in a case in which the measurement information indicates that a measured object is positioned within the detection range, assesses that the object is within the detection range, and in a case in which the measurement information does not indicate that a measured object is positioned within the detection range, assesses that the object is not within the detection range.

11. The information processing apparatus according to claim 10, wherein
the assessment unit assesses whether or not the object is within the detection range in accordance with whether or not the measured object is a registered object that has been preset.

12. The information processing apparatus according to claim 1, wherein
the assessment unit determines the detection range based on a time period required for switching the communication performed by the flying vehicle between the terrestrial communication and the satellite communication.

13. The information processing apparatus according to claim 1, wherein
the assessment unit determines the detection range based on scheduled flight information indicating scheduled flight positions of the flying vehicle at respective times.

14. An information processing method, executed by a processor, the information processing method comprising:
assessing whether or not there is an object different from a flying vehicle within a detection range defined with respect to a position of the flying vehicle during flight; and
switching communication performed by the flying vehicle during flight between terrestrial communication using terrestrial communication equipment and satellite communication using a communication satellite on the condition that the object has been assessed as not being within the detection range in the assessing.
